(19) United States
(12) Patent Application Publication
(10) Pub. No.: US 2023/0082442 A1
(43) Pub. Date: Mar. 16, 2023

(54) RADAR CALIBRATION DEVICE

(71) Applicant: GM Cruise Holdings LLC, San Francisco, CA (US)

(72) Inventor: Daniel Flores Tapia, Fairfield, CA (US)

(21) Appl. No.: 17/473,533

(22) Filed: Sep. 13, 2021

(51) Int. Cl. G01S 7/40

(52) U.S. Cl. CPC G01S 7/4091; G01S 7/4021; G01S 13/931

(57) ABSTRACT

The subject disclosure relates to techniques for calibrating radar sensors and in particular, for facilitating intrinsic radar calibrations, e.g., in autonomous vehicle deployments. In some aspects, a radar calibration of the disclosed technology can include steps for receiving a radar signal comprising one or more known signal parameters, performing power compensation calculations based on the received radar signal, and determining if there is a calibration discrepancy in the radar sensor based on the power compensation calculations. In some aspects, the process can further include steps for applying a calibration offset to the radar sensor if it is determined that there is a calibration discrepancy in the radar sensor. Systems and computer-readable media are also provided.

### BACKGROUND

### 1. Technical Field

The subject technology provides techniques for calibrating radar sensors and in particular, for facilitating automatic processes for performing intrinsic radar calibrations in autonomous vehicle deployments.

### 2. Introduction

Autonomous vehicles (AVs) are vehicles having computers and control systems that perform driving and navigation tasks conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to camera, radar, and/or Light Detection and Ranging (LiDAR) sensors disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a conceptual block diagram of a system used to perform intrinsic radar calibration, according to some aspects of the disclosed technology.

FIG. 2 illustrates a conceptual block diagram of a calibration system, including an active calibration device, according to some aspects of the disclosed technology.

FIGS. 3A and 3B illustrate steps of an example process for calibrating a radar sensor using an active calibration device, according to some aspects of the disclosed technology.

FIG. 4 illustrates steps of an example process for automatically applying calibration offsets based on power compensation calculations performed using an active calibration device.

FIG. 5 illustrates an example system environment that can be used to facilitate autonomous vehicle (AV) dispatch and operations, according to some aspects of the disclosed technology.

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the technology can be practiced. The appended drawings are incorporated herein and constitute a part of the detailed description that includes specific details for the purpose of providing a more thorough understanding of the disclosed technology. However, it will be clear and apparent that the subject technology is not limited to the specific details set forth herein and may be practiced without these details. In some instances, structures and components are shown in block diagram form to avoid obscuring the concepts of the subject technology.

As described herein, some aspects of the present technology include the gathering and use of data available from various sources to improve quality and experience. The present disclosure contemplates that in some instances, this gathered data may include personal information. The present disclosure contemplates that the entities involved with such personal information respect and value privacy policies and practices.

Radar sensors are commonly used to collect range/depth information for various objects in an environment. For example, radar sensors can be deployed on autonomous vehicles (AVs) to collect environmental data used to facilitate navigation and planning operations. In some implementations, the accuracy of collected radar sensor data can degrade over time, for example, due to degraded sensor calibration resulting from device/component aging. In some such instances, radar performance can be improved by calibrating (or re-calibrating) various intrinsic parameters, for example, by adjusting the voltage gain applied to one or more amplifiers in the radar sensor. In some instances, radar calibration may be performed by adjusting a processing chain to alter signal processing performed on the received radar signals, for example, in instances where the degradation factors are known.

Aspects of the disclosed technology provide solutions for performing intrinsic radar sensor calibrations, for example, using an external (extrinsic) signal source, e.g., an active calibration device. The active calibration device can be used to facilitate the intrinsic calibration of an automotive radar sensor, such as a radar sensor integrated into an AV platform. Although several of the examples discussed below relate to the use of radar sensors in the context of AV deployments, it is understood that this disclosure is not limited to a specific vehicle/deployment context. The radar calibration techniques described herein may be applied to the calibration of radar sensors deployed in virtually any context, without departing from the scope of the disclosed technology.

A radar calibration process of the disclosed technology can include the receipt of radar signals (e.g., at a radar sensor), from a signal source (e.g., an active calibration device) positioned at a known distance from the sensor. In some aspects, the received radar signals can correspond with signal parameters (e.g., frequency and/or power characteristics), that are also known by a calibration system associated with the receiving radar sensor. By knowing the distance between the calibration signal source and the receiving radar sensor, as well as the signal parameters, one or more power compensation calculations can be performed, e.g., to determine if radar measurements of the received signal match those of the transmitting signal source. In some instances, the power compensation calculations can be used to determine (or estimate) an estimate power of radar signals transmitted by the calibration signal source. As such, the power compensation calculations can take consideration of the spherical nature of the RF wavefront that is received at the radar sensor.

In some instances, the power compensation calculations, which are based on the received radar signals, may indicate that the receiving radar sensor is adequately calibrated. That is, the power compensation calculations may match expected values for signals received and measured by the radar sensor for the corresponding signal parameters, e.g., frequency and/or power characteristics. In other instances, the power compensation calculations may not match the expected values, i.e., it may be determined that the radar sensor needs to be calibrated. In such instances, one or more radar calibration parameters can be automatically adjusted, e.g., based on a magnitude and direction (sign) of the detected discrepancy. As discussed in further detail below, the need for radar sensor calibrations (or re-calibration) may be determined using thresholds, for example, that indicate a tolerable degree (or amount) of variation between expected signal and received/measured signal, before a sensor re-calibration process is initiated.

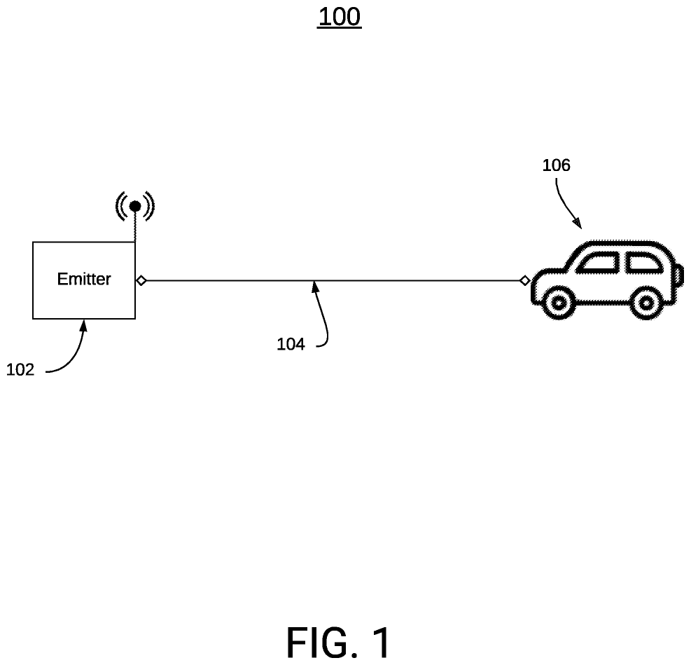

FIG. 1 illustrates a conceptual block diagram of a system 100 used to calibrate a radar sensor, according to some aspects of the disclosed technology. In system 100 a signal source (active calibration device) or emitter 102 is configured to transmit radar waves having predetermined frequency and power characteristics. Emitter 102 is positioned a fixed and known distance 104 from a radar sensor (not illustrated), for example, that is disposed in vehicle 106. By way of example, vehicle 106 can represent an AV that utilizes one or more radar sensors to facilitate navigation and routing functions. As discussed above, radar sensors may be used in other deployment contexts, such as those used in other vehicles, without departing from the scope of the disclosed technology.

In some aspects, distance 104 may be automatically measured or discovered by a calibration system associated with vehicle 106. For example, a radar calibration system associated with vehicle 106 may be provided with information indicating distance 104 using an optical sensor (e.g., a camera), for example, that is configured to read an optical code (not illustrated), such as a QR, corresponding with emitter 102. In some embodiments, distance 104 between emitter 102 and a radar sensor associated with vehicle 106 may be measured using one or more optical sensors, such as a Light Detection and Ranging (LiDAR) sensor associated with vehicle 106.

By knowing distance 104, as well as various parameters (or characteristics) of the radar signals received from emitter 102, such as frequency and/or power characteristics, the radar calibration system can automatically determine if the radar sensor is in need of calibration, and if so, perform the necessary calibration steps. As used herein, the radar calibration system can be, at least in part, integrated with (or part of) a radar sensor associated with the vehicle 106. By way of example, the radar calibration may utilize one or more antennae of the corresponding radar sensor and/or may include hardware and/or software that is integrated with or configured to interoperate with the radar sensor. As discussed in further detail below, sensor calibrations performed by the radar calibration system can include adjusting one or voltage parameters (e.g., voltage gain levels) for amplifiers in a signal processing apparatus of the radar sensor (not illustrated).

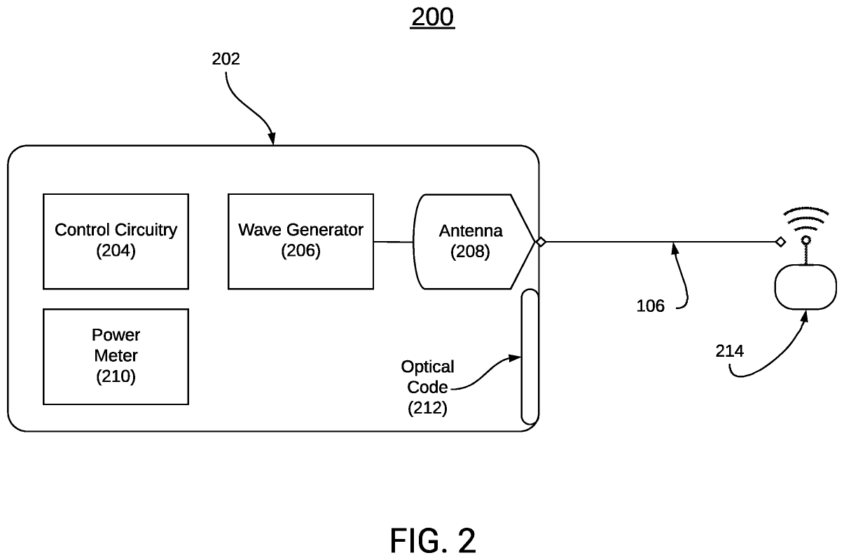

FIG. 2 illustrates a conceptual block diagram of a calibration system setup 200, including an active calibration device 202, and a radar sensor 212, according to some aspects of the disclosed technology. Active calibration device 202 includes a number of interconnected modules, including a controller circuitry module 204 (e.g., controller 204), a wave generator 206, one or more antennae (e.g., antenna 208), a power meter 210, and an optical code 212. Setup 200 also includes a radar sensor 212, for example, that includes the ability to automatically configure (or re-configure) one or more intrinsic radar parameters, such as by modifying offsets for one or more amplifiers, based on signals received from active calibration device 202.

In operation, active calibration device 202 is configured to generate radar signals (e.g., using wave generator 206), and to transmit the radar signals (e.g., via antenna 208) to radar sensor 214. Signal characteristics (signal parameters) of the transmitted signals can be modified by control circuitry 204, for example, using power meter 210 and wave generator 206. The power meter 210 can be configured to measure the RF power emitted by the calibration device 202, while the wave generator 206 is used to produce high fidelity radar waveforms that can be used to tune the radar sensor 214 (e.g., a receiver chain of the radar sensor 214). By modifying the transmitted signals, different object distances and/or velocities may be emulated by the calibration device 202. And by comparing the received signals with known signal parameters, and by knowing its distance 106 from calibration device 202, radar sensor 214 can determine whether or not it is properly calibrated.

In some implementations, the distance 106 between the radar sensor 214 and the calibration device 202 may be indicated using a visual indicator, such as optical code 212. In some instances, optical code 212 may be a one-dimensional code, such as a bar code, or a two-dimensional code, such as a QR code. However, various other types of optical codes that are can be used to represent data (e.g., an indicator of the distance 106) may be used, without departing from the scope of the disclosed technology. By way of example, an optical sensor associated with the radar sensor 214 may be configured to automatically read the optical code 212, and to use the distance information to perform power compensation calculations based on the received radar signals. In some approaches, a power compensation calculator can be configured to compute/estimate the irradiated power at the calibration source. By way of example, the power compensation calculation can compensate for the spherical nature of the wavefront dispersion, e.g., to estimate the signal source power. In the case if discrepancies (e.g., between the estimated signal source power and the actual signal source power), one or more power amplifiers in the receiver stage of the radar sensor can be calibrated/adjusted. By way of example, one or more amplifiers in the receiving radar sensor can be adjusted, until the output power estimated by the radar sensor matches (or is closely approximate to) the irradiated power at the calibration source.

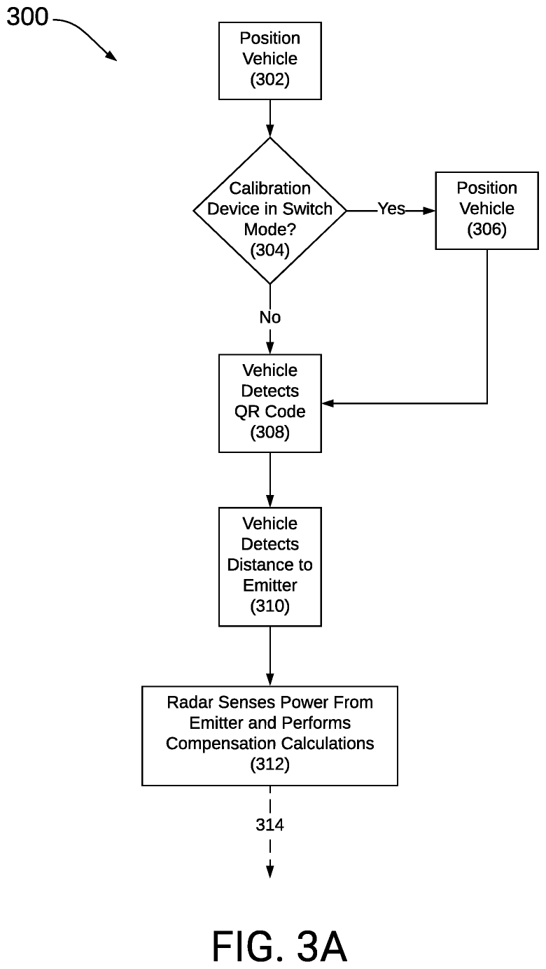

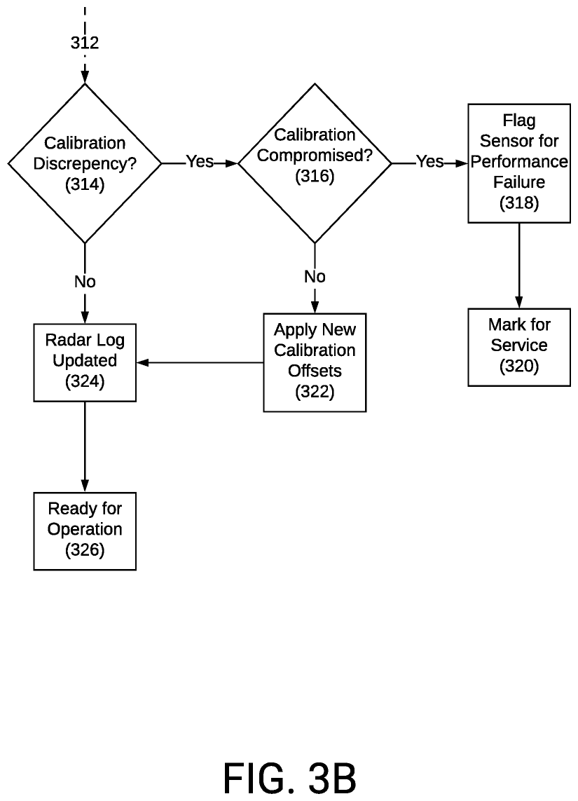

In some examples, power compensation calculations can be used determine if the radar sensor 214 needs recalibration. Processes for calibrating radar sensors (e.g., radar sensor 214) are discussed in further detail with respect to FIGS. 3A and 3B, below.

FIGS. 3A and 3B illustrate steps of an example process 300 for calibrating a radar sensor using an active calibration device, according to some aspects of the disclosed technology. Process 300 beings when a vehicle (such as an AV) is positioned at a fixed location some distance from a calibration device, such as active calibration device 202, discussed above (block 302). Next, it is determined if the calibration device is in ‘switch mode’ (block 304). In some approaches, switch mode allows the proposed device (e.g., a vehicle with a radar sensor) to be repositioned where needed. Typically, in switch mode, the active calibration device will not radiate any RF signals. If it is determined that the active calibration device is in ‘switch mode’, then the vehicle can be positioned/repositioned (block 306). In some aspects, the vehicle may be positioned and oriented in a manner that a radar sensor disposed on (or within) the vehicle, is a pre-determined distance from the active calibration device.

Alternatively, if the calibration device is not is ‘switch mode’, then the vehicle can proceed to detect an optical code (e.g., a QR code) of the calibration device (block), to determine the distance from the vehicle's radar sensor to the calibration device (block 310). As discussed above, in some implementations, other means of detecting distances between the radar sensor and the active calibration device may be used. For example, a LiDAR sensor may be used in conjunction with one or more retroreflectors (or other identifiable artifacts) disposed on the active calibration device (or at an equal distance from the radar sensor). Once a distance of the active calibration device has been determined, the radar sensor can begin to receive radar signals emitted from the calibration device, and to measure/identify various signal characteristics, such as frequency and/or power characteristics (block 312).

As illustrated in FIG. 3B, process 300 then proceeds to block 314, in which it is determined whether or not the receive radar sensor has a calibration discrepancy. In some instances, determinations about the calibration condition of the radar sensor can be based on one or more power compensation calculations that are based on the measured signal parameters of the radar signals received by the radar sensor. For example, if the results of the power compensation calculations indicate that the received signal parameters do not match expected values associated with the radar sensor, then it may be determined that there is a calibration discrepancy. In such instances, it can then be determined if a calibration state of the radar sensor is compromised (block 316). If the calibration is determined to be compromised, then the sensor's malfunction state can be flagged (block 318), and marked for service (block 320). In some implementations, the flag may be raised in response to deviations in certain expected measures, such as radar cross section, velocity, and/or location, for example, that are specified by a QR code associated with the calibration device.

Alternatively, if the calibration is determined to not be compromised (block 316), then new calibration offsets can be applied to the radar sensor based on the power compensation calculations (block 322). Once new calibration offsets have been applied, indications of the updated calibration, i.e., that the calibration was performed, timestamps indicating a time of calibration, and/or data indicating the newly applied offsets, can be written to a radar log (block 324). After the radar sensor has been successfully recalibrated, the sensor can be indicated as ready for operation (block 326).

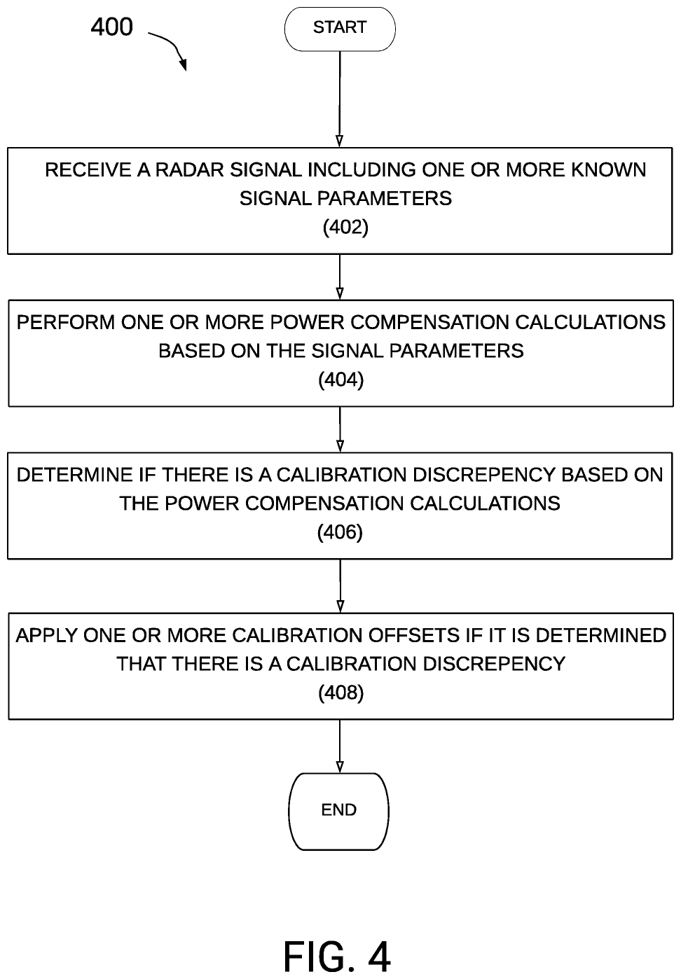

FIG. 4 illustrates steps of an example process 400 for automatically applying calibration offsets based on power compensation calculations performed using an active calibration device. Process 400 begins with step 402 in which a radar signal having known signal parameters is received, e.g., by a calibration system of a radar sensor. Parameters of the received signal be based on a priori frequency and/or power characteristics that are identified or determined by the receiving radar sensor. In some aspects, the frequency and/or power characteristics of the calibration device may be indicated using a visual code, such as a QR code, that is associated with the calibration device. In other aspects, the frequency and/or power characteristics may be known based on communications between the calibration device and the radar sensor, or calibration system that is associated with (or part of) the radar sensor.

The process 400 then proceeds to step 402 in which one or more power compensation calculations are performed based on the received radar signal. In some aspects, the power compensation calculations can be used to determine how characteristics of the radar signals measured by the receiving radar sensor deviate from the actual characteristics of the radar signal that was transmitted by the active calibration device.

The process 400 then proceeds to step 404, in which it is determined if there is a calibration discrepancy in the radar sensor based on the one or more power compensation calculations. As discussed above, the calibration discrepancy can be based on comparisons of an amount of expected power output at the active calibration device, with an estimate that is performed using the radar sensor. Next, at step 406, one or more calibration offsets are applied to the radar sensor if it is determined that there is a calibration discrepancy in the radar sensor. In some aspects, turning/calibration of the radar sensor can be noted or indicated, for example, in a diagnostic log that is stored to a remote memory device, or to a memory device that is internal to the radar sensor.

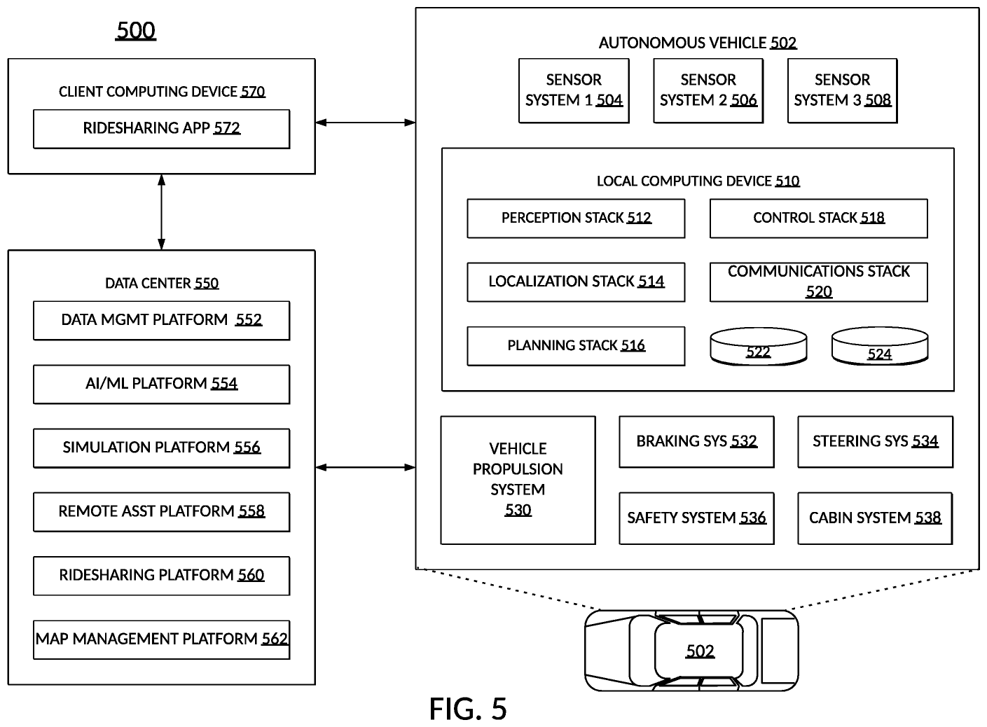

Turning now to FIG. 5 illustrates an example of an AV management system 500. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 500 includes an AV 502, a data center 550, and a client computing device 570. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 502 can navigate about roadways without a human driver based on sensor signals generated by multiple sensor systems 504, 506, and 508. The sensor systems 504-508 can include different types of sensors and can be arranged about the AV 502. For instance, the sensor systems 504-508 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other embodiments may include any other number and type of sensors.

AV 502 can also include several mechanical systems that can be used to maneuver or operate AV 502. For instance, the mechanical systems can include vehicle propulsion system 530, braking system 532, steering system 534, safety system 536, and cabin system 538, among other systems. Vehicle propulsion system 530 can include an electric motor, an internal combustion engine, or both. The braking system 532 can include an engine brake, brake pads, actuators, and/or any other suitable componentry configured to assist in decelerating AV 502. The steering system 534 can include suitable componentry configured to control the direction of movement of the AV 502 during navigation. Safety system 536 can include lights and signal indicators, a parking brake, airbags, and so forth. The cabin system 538 can include cabin temperature control systems, in-cabin entertainment systems, and so forth. In some embodiments, the AV 502 may not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

AV 502 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a planning stack 516, a control stack 518, a communications stack 520, an HD geospatial database 522, and an AV operational database 524, among other stacks and systems.

Perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 522, other components of the AV, and other data sources (e.g., the data center 550, the client computing device 570, third-party data sources, etc.). The perception stack 512 can detect and classify objects and determine their current and predicted locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth.

Mapping and localization stack 514 can determine the AV's position and orientation (pose) using different methods from multiple systems (e.g., GPS, IMUs, cameras, LIDAR, RADAR, ultrasonic sensors, the HD geospatial database 522, etc.). For example, in some embodiments, the AV 502 can compare sensor data captured in real-time by the sensor systems 504-508 to data in the HD geospatial database 522 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

The planning stack 516 can determine how to maneuver or operate the AV 502 safely and efficiently in its environment. For example, the planning stack 516 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another. The planning stack 516 can determine multiple sets of one or more mechanical operations that the AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 516 can select from multiple backup plans to carry out. For example, while preparing to change lanes to turn right at an intersection, another vehicle may aggressively cut into the destination lane, making the lane change unsafe. The planning stack 516 could have already determined an alternative plan for such an event, and upon its occurrence, help to direct the AV 502 to go around the block instead of blocking a current lane while waiting for an opening to change lanes.

The control stack 518 can manage the operation of the vehicle propulsion system 530, the braking system 532, the steering system 534, the safety system 536, and the cabin system 538. The control stack 518 can receive sensor signals from the sensor systems 504-508 as well as communicate with other stacks or components of the local computing device 510 or a remote system (e.g., the data center 550) to effectuate operation of the AV 502. For example, the control stack 518 can implement the final path or actions from the multiple paths or actions provided by the planning stack 516. This can involve turning the routes and decisions from the planning stack 516 into commands for the actuators that control the AV's steering, throttle, brake, and drive unit.

The communication stack 520 can transmit and receive signals between the various stacks and other components of the AV 502 and between the AV 502, the data center 550, the client computing device 570, and other remote systems. The communication stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 520 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 522 can store HD maps and related data of the streets upon which the AV 502 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 524 can store raw AV data generated by the sensor systems 504-508 and other components of the AV 502 and/or data received by the AV 502 from remote systems (e.g., the data center 550, the client computing device 570, etc.). In some embodiments, the raw AV data can include HD LIDAR point cloud data, image data, RADAR data, GPS data, and other sensor data that the data center 550 can use for creating or updating AV geospatial data.

The data center 550 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 502 and client computing device 570. These signals can include sensor data captured by the sensor systems 504-508, roadside assistance requests, software updates, ridesharing pick-up and drop-off instructions, and so forth. In this example, the data center 550 includes a data management platform 552, an Artificial Intelligence/Machine Learning (AI/ML) platform 554, a simulation platform 556, a remote assistance platform 558, a ridesharing platform 560, and map management system platform 562, among other systems.

Data management platform 552 can be a “big data” system capable of receiving and transmitting data at high velocities (e.g., near real-time or real-time), processing a large variety of data, and storing large volumes of data (e.g., terabytes, petabytes, or more of data). The varieties of data can include data having different structure (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management system platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management system platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from the map management system platform 562; modeling the behavior of other vehicles, bicycles, pedestrians, and other dynamic elements; simulating inclement weather conditions, different traffic scenarios; and so on.

The remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

The ridesharing platform 560 can interact with a customer of a ridesharing service via a ridesharing application 572 executing on the client computing device 570. The client computing device 570 can be any type of computing system, including a server, desktop computer, laptop, tablet, smartphone, smart wearable device (e.g., smart watch, smart eyeglasses or other Head-Mounted Display (HMD), smart ear pods or other smart in-ear, on-ear, or over-ear device, etc.), gaming system, or other general purpose computing device for accessing the ridesharing application 572. The client computing device 570 can be a customer's mobile computing device or a computing device integrated with the AV 502 (e.g., the local computing device 510). The ridesharing platform 560 can receive requests to be picked up or dropped off from the ridesharing application 572 and dispatch the AV 502 for the trip.

Map management system platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, UAVs, satellites, third-party mapping services, and other sources of geospatially referenced data. The raw data can be processed, and map management system platform 562 can render base representations (e.g., tiles (2D), bounding volumes (3D), etc.) of the AV geospatial data to enable users to view, query, label, edit, and otherwise interact with the data. Map management system platform 562 can manage workflows and tasks for operating on the AV geospatial data. Map management system platform 562 can control access to the AV geospatial data, including granting or limiting access to the AV geospatial data based on user-based, role-based, group-based, task-based, and other attribute-based access control mechanisms. Map management system platform 562 can provide version control for the AV geospatial data, such as to track specific changes that (human or machine) map editors have made to the data and to revert changes when necessary. Map management system platform 562 can administer release management of the AV geospatial data, including distributing suitable iterations of the data to different users, computing devices, AVs, and other consumers of HD maps. Map management system platform 562 can provide analytics regarding the AV geospatial data and related data, such as to generate insights relating to the throughput and quality of mapping tasks.

In some embodiments, the map viewing services of map management system platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

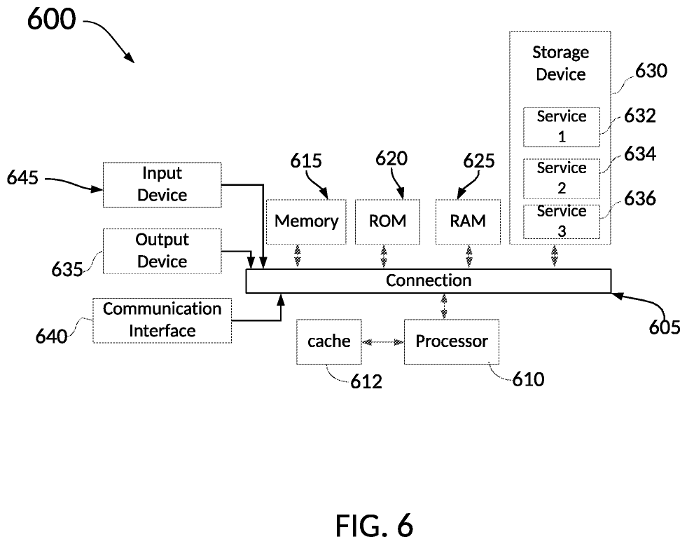

FIG. 6 illustrates an example processor-based system with which some aspects of the subject technology can be implemented. Specifically, FIG. 6 illustrates system architecture 600 wherein the components of the system are in electrical communication with each other using a bus 605. System architecture 600 can include a processing unit (CPU or processor) 610, as well as a cache 612, that are variously coupled to system bus 605. Bus 605 connects various system components including a non-transitory computer-readable storage medium 615, (e.g., read only memory (ROM) 620 and random-access memory (RAM) 625, to processor 610.

System architecture 600 can include a cache of high-speed memory connected directly with, in close proximity to, or integrated as part of the processor 610. System architecture 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. Memory 615 can include multiple different types of memory with different performance characteristics. Processor 610 can include any general purpose processor and a hardware module or software module, such as module 1 (632), module 2 (634), and module 3 (636) stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system architecture 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms. In some instances, multimodal systems can enable a user to provide multiple types of input to communicate with the computing system architecture 600. Communications interface 640 can generally govern and manage the user input and system output. There is no restriction on operating on any particular hardware arrangement and therefore the basic features here may easily be substituted for improved hardware or firmware arrangements as they are developed.

Environmental sensors 650 can include various sensors that are configured to make measurements/detect the surrounding environs and provide corresponding signaling to processor 610. Although environmental sensors 650 can include sensors of virtually any type, in some implementations environmental sensors 650 can include one or more cameras, depth cameras, LiDARs, and/or sonars, etc.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 can include software modules 632, 634, 636, for controlling processor 610. Other hardware or software modules are contemplated. Storage device 630 can be connected to the system bus 605. In one aspect, a hardware module that performs a particular function can include the software component stored in a computer-readable medium in connection with the necessary hardware components, such as the processor 610, bus 605, output device 635, and so forth, to carry out various functions of the disclosed technology.

By way of example, instruction stored on computer-readable media can be configured to cause one or more processors to perform operations including: navigating an autonomous vehicle (AV) along a route terminating in a drop-off location specified by a rider of the AV; detecting an arrival of the AV at the drop-off location; sending location information of the AV to a mobile device associated with the rider; and initializing augment reality (AR) guidance for the rider on the mobile device, wherein the AR guidance is configured to provide the rider with navigation information pertaining to the drop-off location.

By way of further example, instructions stored on computer-readable media can be configured to cause one or more processors to perform operations including: transmitting an autonomous vehicle (AV) ride request from a mobile device to an AV dispatch service, wherein the ride request comprises location information of the mobile device; receiving, at the mobile device, a ride confirmation indicating that an AV has been dispatched to a rider associated with the mobile device; detecting arrival of the AV at a pick-up location associated with the rider; and initializing augment reality (AR) guidance on the mobile device, wherein the AR guidance is configured to provide the rider with navigation information to facilitate pick-up by the AV.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. An apparatus for calibrating a radar sensor, comprising:
at least one memory; and
at least one processor coupled to the at least one memory, the at least one processor configured to:
receive a radar signal comprising one or more known signal parameters;
perform one or more power compensation calculations based on the received radar signal;
determine if there is a calibration discrepancy in the radar sensor based on the one or more power compensation calculations; and
apply one or more calibration offsets to the radar sensor if it is determined that there is a calibration discrepancy in the radar sensor.

2. The apparatus of claim 1, wherein the one or more known signal parameters comprises a frequency of the radar signal, a power of the radar signal, or a combination thereof.

3. The apparatus of claim 1, wherein the one or more power compensation calculations are based on a distance from the radar sensor to an emitter of the radar signal.

4. The apparatus of claim 3, wherein the distance is determined using an optical sensor associated with the radar sensor.

5. The apparatus of claim 1, wherein the one or more power compensation calculations are performed for at least one low speed signal set.

6. The apparatus of claim 1, wherein the one or more power compensation calculations are performed for at least one high speed signal set.

7. The apparatus of claim 1, further comprising:
update a sensor diagnostic log for the radar sensor, based on the one or more calibration offsets.

8. The apparatus of claim 1, wherein apply the one or more calibration offsets to the radar sensor, further comprises:
adjust a voltage offset for one or more amplifiers in the radar sensor.

9. A computer-implemented method for performing intrinsic calibration of a radar sensor, the method comprising:
receiving a radar signal comprising one or more known signal parameters;
performing one or more power compensation calculations based on the received radar signal;
determining if there is a calibration discrepancy in the radar sensor based on the one or more power compensation calculations; and
applying one or more calibration offsets to the radar sensor if it is determined that there is a calibration discrepancy.

10. The computer-implemented method of claim 9, wherein the one or more known signal parameters comprises a frequency of the radar signal, a power of the radar signal, or a combination thereof.

11. The computer-implemented method of claim 9, wherein the one or more power compensation calculations are based on a distance from the radar sensor to an emitter of the radar signal.

12. The computer-implemented method of claim 11, wherein the distance is automatically determined using an optical sensor associated with the radar sensor.

13. The computer-implemented method of claim 9, wherein the one or more power compensation calculations are performed for at least one low speed signal set.

14. The computer-implemented method of claim 9, wherein the one or more power compensation calculations are performed for at least one high speed signal set.

15. The computer-implemented method of claim 9, further comprising:
updating a sensor diagnostic log for the radar sensor, based on the one or more calibration offsets.

16. The computer-implemented method of claim 9, wherein applying the one or more calibration offsets to the radar sensor, further comprises:
adjusting a voltage offset for one or more amplifiers in the radar sensor.

17. A non-transitory computer-readable storage medium comprising at least one instruction for causing a computer or processor to:
receive a radar signal comprising one or more known signal parameters;
perform one or more power compensation calculations based on the received radar signal;
determine if there is a calibration discrepancy in a radar sensor based on the one or more power compensation calculations; and
apply one or more calibration offsets to the radar sensor if it is determined that there is a calibration discrepancy in the radar sensor.

18. The non-transitory computer-readable storage medium of claim 17, wherein the one or more known signal parameters comprises a frequency of the radar signal, a power of the radar signal, or a combination thereof.

19. The non-transitory computer-readable storage medium of claim 17, wherein the one or more power compensation calculations are based on a distance from the radar sensor to an emitter of the radar signal.

20. The non-transitory computer-readable storage medium of claim 19, wherein the distance is determined using an optical sensor associated with the radar sensor.
